(19) United States
(12) Patent Application Publication
(10) Pub. No.: US 2026/0149993 A1
(43) Pub. Date: May 28, 2026

(54) CSI REPORTING BASED ON MULTIPLE POWER OFFSETS

(71) Applicant: Telefonaktiebolaget LM Ericsson (PUBL), Stockholm (SE)

(72) Inventors: Ajit NIMBALKER, Dublin, CA (US); Ravikiran NORY, Dublin, CA (US); Stephen GRANT, PLEASANTON, CA (US); Sina MALEKI, Malmö (SE); Helka-Liina MÄÄTTÄNEN, Espoo (FI); Ali NADER, Malmö (SE)

(21) Appl. No.: 19/150,036

(22) PCT Filed: Feb. 19, 2024
(86) PCT No.: PCT/SE2024/050166

§ 371 Date: Jul. 22, 2025

Related U.S. Application Data
(60) Provisional application No. 63/485,563, filed on Feb. 17, 2023.

(51) Int. Cl. H04W 24/10; H04W 52/30

(52) U.S. Cl. CPC H04W 24/10; H04W 52/30

(57) ABSTRACT

A method is performed by a wireless device for channel state information, CSI, reporting based on a power offset. The method comprises: receiving (2112) a CSI configuration. The CSI configuration associates a CSI trigger state with one or more power offset values and a set of one or more non-zero power, NZP, CSI reference signal, RS, resources. The method further comprises receiving (2114) a downlink control information, DCI, comprising an indication of the CSI trigger state; determining (2116) one or more CSI measurements based on at least the one or more NZP-CSI-RS resources and the one or more power offset values associated with the received CSI trigger state; and transmitting (2118) one or more CSI reports comprising the one or more CSI measurements.

### TECHNICAL FIELD

Embodiments of the present disclosure are directed to wireless communications and, more particularly, to channel state information (CSI) reporting based on multiple power offsets.

### BACKGROUND

The network power consumption for New Radio (NR) is said to be reduced compared to Long Term Evolution (LTE) because of its lean design. In the current implementation, however, NR will most likely consume more power compared to LTE, e.g., due to the higher bandwidth and more so due to introduction of additional elements such as 64 transmit/receive (TX/RX) ports with associated digital radio frequency (RF) chains. Because the network is expected to be able to support the user equipment (UE) with its maximum capability (e.g., throughput, coverage, etc.), the network may need to use full configuration even when the maximum network support is actually rarely needed by the UEs.

In addition, an increased number of TX/RX ports also leads to an increase in the number of reference signals (e.g., channel state information reference signal (CSI-RS)) to be transmitted (and to be measured by the UE) for a proper signal detection. Thus, the additional TX/RX ports may result in another additional power consumption, i.e., to transmit a larger number of CSI-RS to the UEs. Furthermore, the larger number of CSI-RS transmissions may also consume the valuable channel state information resources.

The network may achieve energy saving by applying antenna muting. To provide high-rate cell-edge coverage and high spatial resolution, an NR gNB may deploy large antenna arrays with hundreds of antenna elements and up to 32 ports. The energy cost associated with RF (power amplifier (PA) and low noise amplifier (LNA)), digital processing (e.g., beam forming (BF)), and baseband processing associated with such an array is high. In some scenarios (few users, low load, reduced user transmission power (TP) or latency requirements), maintaining sufficient user and system performance may not require the full antenna gNB array. The gNB may then deactivate or mute parts of the antenna panel and transmit with a subset of antenna elements and transmission ports.

A CSI-RS resource may span 1, 2, or 4 orthogonal frequency-division multiplexing (OFDM) symbols, such as:
One symbol for 1, 2, 4, 8, 12 ports;
Two symbols for 4, 8, 12, 16 ports; and
Four symbols for 24, 32 ports.

A CSI-RS resource may start at any symbol (0-13) within a slot:
Is defined by a single start symbol for 1 symbol CSI-RS, 2 symbol CSI-RS, and 4 symbols with time division-orthogonal cover code (TD-OCC) span 4; and
Is defined by two start symbol indices in the 4 symbol CSI-RS 2+2 with TD-OCC span 2.

Some components may be mapped to frequency with granularity of component size, 1, 2, or 4 subcarriers. The same subcarriers may be used across all symbols in a resource.

Resource element (RE) level multiplexing with tracking reference signal (TRS)/demodulation reference signal (DMRS) is possible in the same OFDM symbol. In most cases, RE level multiplexing with DMRS is not possible, such as shown in FIG. 1.

FIG. 1 is a time/frequency diagram illustrating an example of RE level multiplexing. The examples include 1 symbol resource, 2 symbol resource, 4 symbol resource adjacent, and 4 symbol resource pairwise adjacent.

NR supports the following three types of CSI-RS transmissions:
Aperiodic CSI-RS Transmission: This is a one-shot CSI-RS transmission that can be triggered by a gNB via downlink control information (DCI) in any slot. Here, one-shot means that CSI-RS transmission only happens once per trigger in one slot. The CSI-RS resources (i.e., the resource element locations that consist of subcarrier locations and OFDM symbol locations) for aperiodic CSI-RS are preconfigured to UEs via higher layer signaling. The transmission of aperiodic CSI-RS is triggered via DCI. As shown in Table 1, aperiodic CSI-RS can be used for aperiodic CSI reporting.
Periodic CSI-RS Transmission: These CSI-RS transmissions are preconfigured by higher layer signaling and the pre-configuration includes parameters such as periodicity and slot offset. Periodic CSI-RS is only controlled by higher layer signaling. That is, the periodic CSI-RS transmission starts following RRC configuration following the configured parameters. As shown in Table 1, periodic CSI-RS can be used for periodic CSI reporting, semi-persistent CSI reporting and aperiodic CSI reporting.
Semi-Persistent CSI-RS Transmission: Similar to periodic CSI-RS, resources for semi-persistent CSI-RS transmissions are preconfigured via higher layer signaling with parameters such as periodicity and slot offset. However, unlike periodic CSI-RS, a dynamic allocation activation signaling via a medium access control (MAC) control element (CE) is needed to begin transmission of semi-persistent CSI-RS on the preconfigured resources. Furthermore, semi-persistent CSI-RS is transmitted for a limited time duration until the activated semi-persistent CSI-RS is deactivated via a deactivation signaling via a MAC CE. As shown in Table 1, semi-persistent CSI-RS can be used for semi-persist.

TABLE 1
Triggering/Activation of CSI Reporting for the possible CSI-RS Configurations.

| CSI-RS | Periodic CSI | Semi-Persistent CSI | Aperiodic CSI |
|---|---|---|---|
| Configuration | Reporting | Reporting | Reporting |
| Periodic CSI-RS | No dynamic | For reporting on | Triggered by DCI; |
| | triggering/activation | physical uplink | additionally, sub- |
| | | control channel | selection indication |
| | | (PUCCH), the UE | as described in |
| | | receives an activation | clause 6.1.3.13 of |
| | | command, as | [TS 38.321] |
| | | described in clause | possible as defined |
| | | 6.1.3.16 of [TS | in Clause 5.2.1.5.1. |
| | | 38.321]; for reporting | |
| | | on PUSCH, the UE | |
| | | receives triggering on | |
| | | DCI | |
| Semi-Persistent | Not Supported | For reporting on | Triggered by DCI; |
| CSI-RS | | PUCCH, the UE | additionally, sub- |
| | | receives an activation | selection indication |
| | | command, as | as described in |
| | | described in clause | clause 6.1.3.13 of |
| | | 6.1.3.16 of [TS | [TS 38.321] |
| | | 38.321]; for reporting | possible as defined |
| | | on PUSCH, the UE | in Clause 5.2.1.5.1. |
| | | receives triggering on | |
| | | DCI | |
| Aperiodic CSI-RS | Not Supported | Not Supported | Triggered by DCI; |
| | | | additionally, sub- |
| | | | selection indication |
| | | | as described in |
| | | | clause 6.1.3.13 of |
| | | | [TS 38.321] |
| | | | possible as defined |
| | | | in Clause 5.2.1.5.1. |

The network may configure CSI-RS with different settings (e.g. number of antenna ports, CSI-RS resources, etc.) and use the UE feedback (e.g., CSI, link quality, etc.) to assess the link conditions and make suitable scheduling decisions (e.g., number of ports, codebook to use, etc.) when scheduling the UE. The network may also use different settings to identify if the network can still serve the UE sufficiently well while at the same time reducing network energy cost (e.g., by reducing number of antenna ports used for the scheduling data to the UE.) For example, the network can trigger an aperiodic CSI-RS transmission and reporting via DCI 0_1 and/or DCI 0_2 using the below field (e.g., in DCI 0_1).
CSI request-0, 1, 2, 3, 4, 5, or 6 bits determined by higher layer parameter reportTriggerSize.

Typically, for aperiodic CSI (A-CSI) trigger and reporting, a UE in connected mode is configured with a first number of trigger states (e.g., 128) via radio resource control (RRC) signaling. However, the DCI field size for A-CSI trigger state indication is limited to 6 bits, implying only maximum of 64 trigger states can be active at a time and only these can be triggered via the DCI (e.g., via DCI 0_1/0_2). A MAC CE can be used for aperiodic CSI trigger state selection to indicate the active trigger states. The active trigger state budget is limited, and the trigger states are used for many purposes such as CSI measurement and reporting for link adaptation, beam management (including layer 1 reference signal received power (L1-RSRP) reporting, L1 signal to interference noise ratio (SINR) reporting, etc.). An example is shown in FIG. 2.

FIG. 2 illustrates example trigger states. The active trigger states may be used for A-CSI triggering via DCI.

In TS 38.331, the information element (IE) CSI-AperiodicTriggerStateList configures the UE with a list of trigger states. If the number of configured trigger states is more than what is possible to indicate to the UE using DCI, a MAC CE is used to down select from the RRC configured list.

Each trigger state consists of a list of CSI-AssociatedReportConfigInfo and each info consists of association between channel and interference resources to be measured by the UE to a report configuration which configures UE how to and what to report based on the measurements.

The CSI-AperiodicTriggerStateList IE is used to configure the UE with a list of aperiodic trigger states. Each codepoint of the DCI field “CSI request” is associated with one trigger state (see TS 38.321, clause 6.1.3.13). Upon reception of the value associated with a trigger state, the UE will perform measurement of CSI-RS, CSI-interference measurement (IM) and/or synchronization signal block (SSB) (reference signals) and aperiodic reporting on L1 according to all entries in the associatedReportConfigInfoList for that trigger state.

CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

```
(SIZE(1..maxNrofReportConfigPerAperiodicTrigger)) OF CSI-
AssociatedReportConfigInfo,
  ...,
  [[
```

| | |
|---|---|
| ap-CSI-MultiplexingMode-r17 | ENUMERATED {enabled} |

| | |
|---|---|
| OPTIONAL | -- Need R |

]]
}

| CSI-AssociatedReportConfigInfo ::= | | SEQUENCE { |
|---|---|---|
| reportConfigId | | CSI-ReportConfigId, |
| resourcesForChannel | | CHOICE { |
| nzp-CSI-RS | | SEQUENCE { |
| | resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId

| | |
|---|---|
| OPTIONAL | -- Cond Aperiodic |

},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |
| ResourceSetsPerConfig) | OPTIONAL, -- Cond CSI-IM-ForInterference |

nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

```
  ...,
  [[
```

| resourcesForChannel2-r17 | | CHOICE { |
|---|---|---|
| nzp-CSI-RS2-r17 | | SEQUENCE { |
| | resourceSet2-r17 | INTEGER (1..maxNrofNZP-CSI-RS- |

ResourceSetsPerConfig),

| | |
|---|---|
| qcl-info2-r17 | SEQUENCE (SIZE(1..maxNrofAP-CSI-RS- |

ResourcesPerSet)) OF TCI-StateId

| | |
|---|---|
| OPTIONAL | -- Cond Aperiodic |

},

| | |
|---|---|
| csi-SSB-ResourceSet2-r17 | INTEGER (1..maxNrofCSI-SSB- |

ResourceSetsPerConfigExt)
}

| | |
|---|---|
| OPTIONAL, | -- Cond NoUnifiedTCI |

| | |
|---|---|
| csi-SSB-ResourceSetExt | INTEGER (1..maxNrofCSI-SSB- |
| ResourceSetsPerConfigExt) | OPTIONAL -- Need R |

]]
}
-- TAG-CSI-APERIODICTRIGGERSTATELIST-STOP
-- ASN1STOP

The network may configure up to 16 semi-persistent non-zero power (NZP)-CSI-reference signal (RS) resource sets. The information about (de-)activation of these semi-persistent CSI reference signal transmissions is provided to the UEs using a MAC-CE (referred to as SP CSI-RS/CSI-IM Resource Set Activation/Deactivation MAC CE). This MAC-CE includes an Active/Deactivate (A/D) flag and one more identities for the set of semi-persistent CSI resources (semi persistent (SP) CSI-RS Resource Set ID) and an associated transmission configuration indicator (TCI) state, as illustrated in FIG. 3.

The reporting of the CSI reports from the UE on the activated SP CSI Resource Sets can be done on either the PUCCH or on physical uplink shared channel (PUSCH). Whether the reporting is done on PUSCH or PUCCH and whether it is reported on a periodic/semi-persistent/aperiodic basis is selected based on the CSI reporting configuration (CSI-ReportConfig) provided via RRC in which there is a parameter reportConfigType as follows:

| CSI-ReportConfig ::= | | SEQUENCE { |
|---|---|---|
| reportConfigId | | CSI-ReportConfigId, |
| carrier | | ServCellIndex |
| OPTIONAL, | -- Need S | |
| resourcesForChannelMeasurement | | CSI-ResourceConfigId, |
| csi-IM-ResourcesForInterference | | CSI-ResourceConfigId |
| OPTIONAL, | -- Need R | |
| nzp-CSI-RS-ResourcesForInterference | | CSI-ResourceConfigId |
| OPTIONAL, | -- Need R | |
| reportConfigType | | CHOICE { |
| periodic | | SEQUENCE { |
| | reportSlotConfig | CSI-ReportPeriodicityAndOffset, |
| | pucch-CSI-ResourceList | SEQUENCE (SIZE |

(1..maxNrofBWPs)) OF PUCCH-CSI-Resource
},

| semiPersistentOnPUCCH | | SEQUENCE { |
|---|---|---|
| | reportSlotConfig | CSI-ReportPeriodicityAndOffset, |
| | pucch-CSI-ResourceList | SEQUENCE (SIZE |

(1..maxNrofBWPs)) OF PUCCH-CSI-Resource
},

| semiPersistentOnPUSCH | | SEQUENCE { |
|---|---|---|
| | reportSlotConfig | ENUMERATED {sl5, sl10, sl20, |

sl40, sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| aperiodic | | SEQUENCE { |
|---|---|---|
| | reportSlotOffsetList | SEQUENCE (SIZE (1..maxNrofUL- |

```
Allocations)) OF INTEGER(0..32)
    }
  },
...
```

The aperiodic report is always on the PUSCH (triggered by a DCI by the network as described above) while the periodic report uses the PUCCH resources unless there is a coinciding PUSCH resource allocated to the UE.

The triggering mechanisms of the semi-persistent CSI-reporting are somewhat different depending on whether the report is to be transmitted on PUCCH or PUSCH.

For PUCCH, the trigger is a MAC-CE (referred to as SP CSI reporting on PUCCH Activation/Deactivation MAC CE):

FIG. 4 illustrates an example of a MAC CE. In FIG. 4, the S fields indicated the (de-)activation status of the report configurations configured by RRC via csi-ReportConfigToAddModList. For example, S0 refers to the report configuration that includes PUCCH resources for SP CSI reporting in the indicated bandwidth part (BWP) and has the lowest CSI-ReportConfigld within the list with type set to semiPersistentOnPUCCH, S1 refers to the report configuration that includes PUCCH resources for SP CSI reporting in the indicated BWP and has the second lowest CSI-ReportConfigld, and so on.

For PUSCH, the triggering is done by a DCIs (field CSI Request-0, 1, 2, 3, 4, 5, or 6 bits determined by higher layer parameter reportTriggerSize) with cyclic redundancy check (CRC) scrambled by SP-CSI-radio network temporary identifier (RNTI). The DCI activates one of the trigger states configured via RRC configuration of CSI-SemiPersistentOnPUSCH-TriggerStateList. This is similar to the aperiodic trigger states described above, except that only a maximum of 64 trigger states can be configured, thus no sub-selection MAC-CE needed.

There currently exist certain challenges. For example, for the purposes of network energy saving, a gNB may attempt to operate (e.g., transmit a physical downlink shared channel (PDSCH)) with reduced transmission power. Alternately, the gNB may attempt to transmit CSI-RS with a reduced transmission power compared to SSB. However, to identify the suitable power setting without compromising performance (e.g., quality of service, PDSCH throughput), in current NR system, a gNB has to configure multiple NZP-CSI-RS resources, each with a different one or more of the PDSCH-to-CSI-RS power offsets value (e.g., powerControlOffset, powerControlOffsetSS) and request the UE to measure and report CSI separately. Furthermore, the gNB has to configure multiple CSI report settings each with a different resource setting, leading to unnecessary transmission/configuration overhead, particularly for aperiodic CSI request.

### SUMMARY

As described above, certain challenges currently exist with power consumption for New Radio (NR) and future radio access technologies (RATs) such as sixth generation (6G). Certain aspects of the present disclosure and their embodiments may provide solutions to these or other challenges. For example, particular embodiments provide systems and methods for the aperiodic and/or semi-persistent channel state information (CSI) measurement/reporting by which a CSI trigger state is used to request CSI measurement/report for multiple power offset settings (e.g., power offset of physical downlink shared channel (PDSCH) resource element (RE) to non-zero power (NZP) CSI reference signal (RS) resource element (RE)) using a single CSI-RS resource/CSI resource setting/CSI report setting. Other variants to achieve a similar effect are also disclosed herein.

In some embodiments, the power offset may be incorporated to the CSI-ReportConfig, which facilitates configuring a user equipment (UE) to report CSI assuming the power offset for any of the aperiodic, semi-persistent, or periodic report.

Particular embodiments provide an information element (IE) in one or more of the substructures of the CSI-MeasConfig such as in the CSI trigger state definition or CSI-ReportConfig or CSI-AssociatedReportConfigInfo IE, where the IEs indicate one or more power offset values, where each power offset value indicates a power offset between a PDSCH RE and an RE of the NZP-CSI-RS resource (powerControlOffset) and/or power offset in decibel (dB) of NZP-CSI-RS RE to SSS RE (powerControlOffsetSS). Particular embodiments provide another higher layer configuration for new report setting for including multiple CSI values (e.g., for one or more power offset settings) within a single report.

According to some embodiments, a method is performed by a wireless device for CSI reporting based on a power offset. The method comprises: receiving a CSI configuration. The CSI configuration associates a CSI trigger state with one or more power offset values and a set of one or more NZP-CSI-RS resources. The method further comprises receiving a DCI comprising an indication of the CSI trigger state; determining one or more CSI measurements based on at least the one or more NZP-CSI-RS resources and the one or more power offset values associated with the received CSI trigger state; and transmitting one or more CSI reports comprising the one or more CSI measurements.

In particular embodiments, the CSI configuration associates the CSI trigger state with two or more power offset values and a set of one or more NZP-CSI-RS resources.

In particular embodiments, the one or more power offset values associated with the CSI trigger state comprise an offset relative to a power offset value configured for an associated NZP-CSI-RS resource or override a power offset configured for an associated NZP-CSI-RS resource.

In particular embodiments, the power offset value comprises a power offset between a RE of a PDSCH and a RE of a NZP-CSI RS resource or a power offset between the NZP-CSI-RS resource and an RE of a SS/PBCH block.

In particular embodiments, the CSI trigger state corresponds to aperiodic CSI reporting or semi-static CSI reporting on a PUSCH.

In particular embodiments, the CSI trigger state is associated with the one or more power offset values based on a trigger state configuration comprising one or more power offset values, based on a NZP-CSI-RS resource configuration comprising one or more power offset values, based on a NZP-CSI-RS resource set configuration comprising one or more power offset values, and/or based on a report configuration comprising one or more power offset values.

In particular embodiments, the one or more CSI reports comprise an indication of one or more power offsets used for generating the CSIs in the one or more CSI reports.

In particular embodiments, the one or more CSI reports comprise CSIs for a fewer number of power offsets than a number of power offsets configured in a CSI report configuration.

In particular embodiments, the method further comprises transmitting to a network node an indication of a number of simultaneous power offsets the wireless device is capable of supporting in the one or more CSI reports.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless receiver described above.

According to some embodiments, a method performed by a network node comprises transmitting a CSI configuration to a wireless device. The CSI configuration associates a CSI trigger state with one or more power offset values and one or more NZP-CSI-RS resources. The method further comprises transmitting a DCI comprising an indication of the CSI trigger state to the wireless device and receiving from the wireless device one or more CSI reports comprising one or more CSI measurements based on at least the one or more NZP-CSI-RS resources and the one or more power offset values associated with the CSI trigger state.

In particular embodiments, the CSI configuration associates the CSI trigger state with two or more power offset values and a set of one or more NZP-CSI-RS resources.

In particular embodiments, the method further comprises receiving from the wireless device an indication of a number of simultaneous power offsets the wireless device is capable of supporting in one or more CSI reports.

According to some embodiments, a network node comprises processing circuitry operable to perform any of the methods of network node described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments improve CSI measurement and reporting mechanism at the UE while reducing signaling/indication overhead and providing opportunity for increased network energy savings by reducing downlink transmission power for certain channels/signals.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a time/frequency diagram illustrating an example of resource element (RE) level multiplexing;

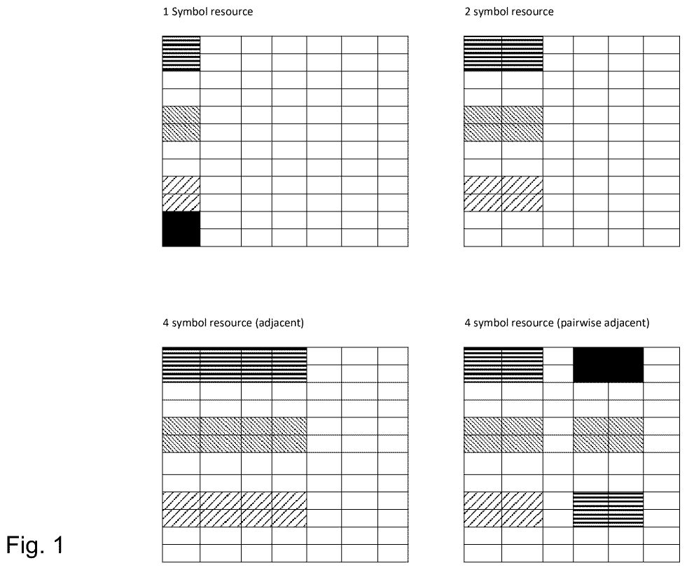

FIG. 2 illustrates example trigger states:

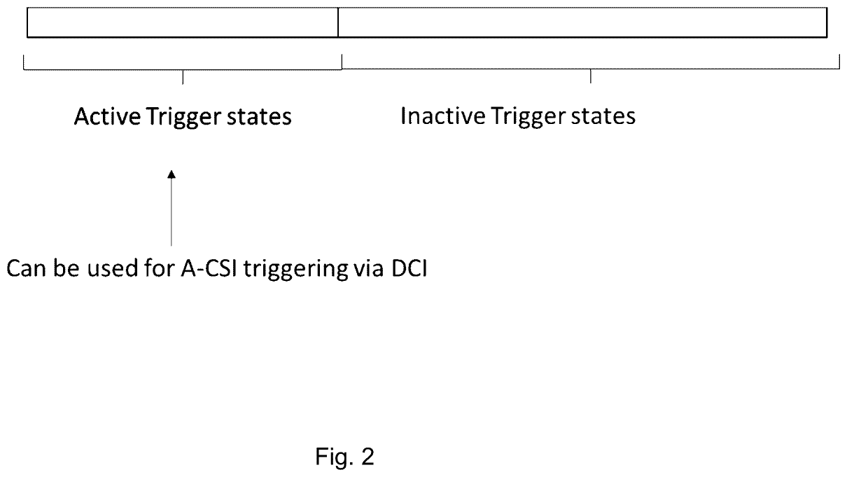

FIG. 3 illustrates an example of a medium access control (MAC) control element (CE);

FIG. 4 illustrates another example of a MAC CE;

FIG. 5 is a table illustrating an example setting of a trigger state, according to particular embodiments;

FIG. 6 is a table illustrating another example setting of a trigger state, according to particular embodiments:

FIG. 7 is a table illustrating another example setting of a trigger state, according to particular embodiments:

FIG. 8 illustrates example ASN.1 for a range of power offset:

FIG. 9 illustrates another example ASN.1 for a range of power offset:

FIG. 10 illustrates an example configuration, according to particular embodiments;

FIG. 11 is a table illustrating an example of power offset values, according to a particular embodiment:

FIG. 12 illustrates another example configuration, according to a particular embodiment:

FIG. 13 is a table illustrating another example of power offset values, according to a particular embodiment:

FIG. 14 illustrates another example configuration, according to a particular embodiment:

FIG. 15 illustrates an example communication system, according to certain embodiments:

FIG. 16 illustrates an example user equipment (UE), according to certain embodiments:

FIG. 17 illustrates an example network node, according to certain embodiments:

FIG. 18 illustrates a block diagram of a host, according to certain embodiments:

FIG. 19 illustrates a virtualization environment in which functions implemented by some embodiments may be virtualized, according to certain embodiments:

FIG. 20 illustrates a host communicating via a network node with a UE over a partially wireless connection, according to certain embodiments:

FIG. 21 illustrates a method performed by a wireless device, according to certain embodiments; and

FIG. 22 illustrates a method performed by a network node, according to certain embodiments.

### DETAILED DESCRIPTION

As described above, certain challenges currently exist with power consumption for New Radio (NR) and future radio access technologies (RATs) such as sixth generation (6G). Certain aspects of the present disclosure and their embodiments may provide solutions to these or other challenges. For example, particular embodiments provide systems and methods for the aperiodic and/or semi-persistent channel state information (CSI) measurement/reporting by which a CSI trigger state is used to request CSI measurement/report for multiple power offset settings (e.g., power offset of physical downlink shared channel (PDSCH) resource element (RE) to non-zero power (NZP) CSI reference signal (RS) resource element (RE)) using a single CSI-RS resource/CSI resource setting/CSI report setting.

Particular embodiments are described more fully with reference to the accompanying drawings. Other embodiments, however, are contained within the scope of the subject matter disclosed herein, the disclosed subject matter should not be construed as limited to only the embodiments set forth herein: rather, these embodiments are provided by way of example to convey the scope of the subject matter to those skilled in the art.

Particular embodiments provide methods by which a user equipment (UE) may efficiently measure and report CSI for one or more power offset settings (e.g., powerControlOffset: power offset between a PDSCH RE and an RE of the NZP-CSI-RS resource or powerControlOffsetSS: power offset between NZP-CSI-RS resource RE and SSS RE) to aid network energy savings.

For the sake of simplicity, the examples below are on the powerControlOffset case. However, the examples are equally applicable to powerControlOffsetSS and combinations of both powerControlOffset and powerControlOffsetSS.

An example is used in this disclosure to illustrate the disclosed systems and methods. In this example, a gNB wants a UE to measure and report CSI according to five different power offset settings (power offset between a PDSCH RE and an RE of the NZP-CSI-RS resource to be 0 dB, 3 dB, 6 dB, 9 dB or 12 dB). In some cases, the gNB may want the UE to report a subset of CSIs and corresponding power offset setting, e.g. such as two of them yielding the best throughput. Some options are disclosed to achieve one or more of these.

### Option 0

Currently in NR system, there is the following restriction (38.2140-h30): “For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one CSI-IM/NZP-CSI-RS resource set from the Resource Setting,” and “For semi-persistent reporting on PUSCH, a set of trigger states are higher layer configured by CSI-SemiPersistentOnPUSCH-TriggerStateList, where the CSI request field in DCI scrambled with SP-CSI-RNTI activates one of the trigger states.” Furthermore, in the RRC specifications when the CSI-ResourceConfig is configured, in the semi-persistent or periodic case, only 1 CSI-RS Resource Set may be configured, see from 38.331:

NZP-CSI-RS-ResourceSetList is a list of references to NZP-CSI-RS resources used for beam measurement and reporting in a CSI-RS resource set.

If resourceType is set to ‘aperiodic’, the network configures up to maxNrofNZP-CSI-RS-ResourceSetsPerConfig resource sets. If resourceType is set to ‘periodic’ or ‘semi Persistent’ and groupBasedBeamReporting-v1710 is not configured in IE CSI-ReportConfig, the network configures 1 resource set.

These restrictions imply that to configure a UE to report CSI for different power offsets, it would be necessary to configure multiple report settings or multiple entries in the associatedReportConfigInfoList, each associated with a different resource setting. The report settings may be associated with either a single trigger state, or they may be associated with separate trigger states. In either case, such a configuration is highly undesirable because it either consumes too much of the UE's limited capability on number of configured report settings, or implies that multiple DCIs would need to be used to trigger measurements for different offsets.

To be able to request CSI by a single DCI for different power offsets using the same report setting (e.g., reportQuantity, time restriction for measurement, etc.), specification updates are needed.

The above restrictions may be relaxed for enhanced CSI reporting over multiple power offsets. This can, e.g., be done by UE capability where the UE indicates that it supports the following: “when UE is configured with the aperiodic trigger state list, when a Resource Setting linked to a CSI-ReportConfig has multiple aperiodic resource sets, more than one aperiodic CSI-RS resource sets from the Resource Setting can be associated with a trigger state.”

In some embodiments, semi-static/periodic reporting may be allowed to configure the UE with multiple resource sets.

For a trigger state and for the purposes of CSI reporting, if a Resource Setting linked to a CSI-ReportConfig has multiple aperiodic or semi-persistent resource sets, more than one of the aperiodic/semi-persistent CSI-RS resource sets from the Resource Setting may be associated with the trigger state.

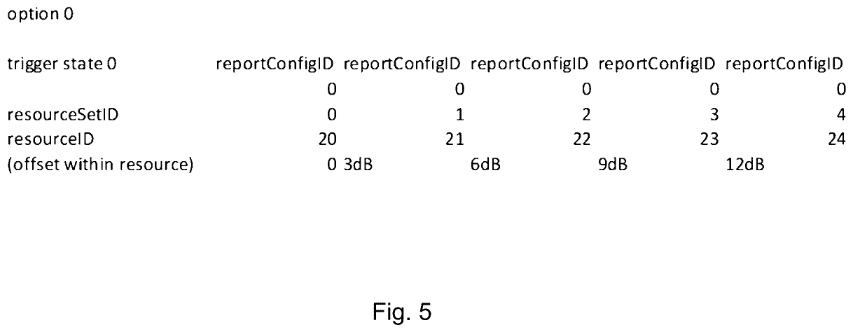

FIG. 5 is a table illustrating an example setting of a trigger state, according to particular embodiments. FIG. 5 illustrates an example setting of trigger state 0. Here, the UE configures different power offset setting values (0 dB, 3 dB, etc.) in the NZP-CSI-RS resource associated with each different resource set. Thus, in some examples, when the UE receives a DCI with trigger state 0, the UE may measure and report CSI according to the five columns shown in FIG. 5

### Option 1/1A

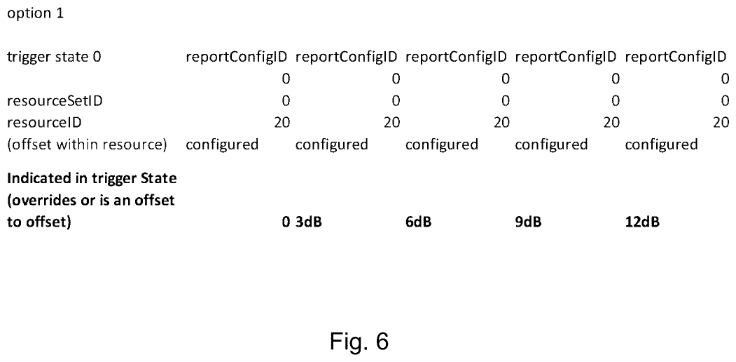

FIG. 6 is a table illustrating another example setting of a trigger state, according to particular embodiments. FIG. 6 illustrates setting of trigger state 1. Here, the UE can configure different power offset setting values (0) dB, 3 dB, etc.) in the trigger state, which may be used to override or offset with respect to the power offset setting in an NZP-CSI-RS resource. The UE may be configured with a single report setting and/or single resource setting and an associated list of power offset values for a trigger state or an entry(s) in the associatedReportConfigInfoList associated with a trigger state.

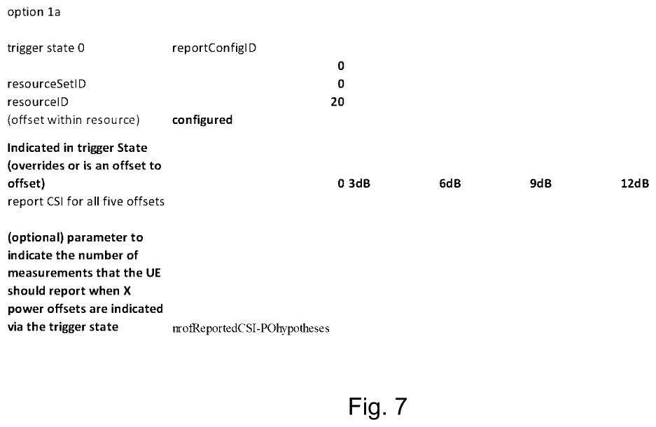

FIG. 7 is a table illustrating another example setting of a trigger state, according to particular embodiments. FIG. 7 illustrates setting of trigger state 1a.

In some embodiments, a UE may be configured with the following: 1) a CSI-RS resource set containing an NZP-CSI-RS resource, 2) one or more CSI Resource Settings (i.e., CSI-ResourceConfig) each associated with the CSI-RS resource set where each CSI Resource Setting indicates that the CSI-RS resource set is aperiodic/semi-persistent/periodic. 3) one or more CSI Report Settings (i.e., CSI-ReportConfig), each associated with one of the one or more CSI Resource Settings. The UE is configured with an aperiodic/semi-persistent trigger state list (i.e., CSI-AperiodicTriggerStateList or semiPersistentOnPUSCH-TriggerStateList) for which at least one trigger state configuration is associated with the following: 1) an identifier or a list of identifiers of the one or more CSI Report Setting(s), where each identifier is associated with an identifier of the CSI-RS resource set and 2) one or more power offset values, where each power offset value indicates a power offset between a PDSCH RE and an RE of the NZP-CSI-RS resource.

In an example, one or more power offset values may be included in at least one of IE CSI-ReportConfig, CSI-AperiodicTriggerState or CSI-AssociatedReportConfigInfo. If included in CSI-AperiodicTriggerState, the one or more power offsets may be associated with one or more subsets of entry(s) in the associatedReportConfigInfoList associated with the trigger state.

In some embodiments, the UE may receive a DCI containing an indication of the trigger state configuration for CSI reporting and an indication of resources for uplink transmission of the CSI report. The UE may further receive the NZP-CSI-RS resource associated with the trigger state. The UE may determine one or more channel state information measurements associated with the NZP-CSI-RS resource based on one or more of the power offset values. The UE may transmit at least one or more of channel state information reports on the uplink resources, where the CSI reports may contain one or more of the following: a resource information (RI), a channel quality indicator (CQI), a precoding matrix indicator (PMI), a CSI-RS resource indicator (CRI), a signal to interference noise ratio (SINR), a received signal reference power (RSRP), and a received signal reference quality (RSRQ).

In some embodiments, a UE may be configured with the following:
a CSI-RS resource set containing an NZP-CSI-RS resource,
one or more CSI Resource Settings (i.e., CSI-ResourceConfig) each associated with the CSI-RS resource set where each CSI Resource Setting indicates that the CSI-RS resource set is aperiodic or semi-persistent or periodic,
one or more CSI Report Settings (i.e., CSI-ReportConfig), each associated with one of the one or more CSI Resource Settings,
an aperiodic or semi-persistent trigger state list (i.e., CSI-AperiodicTriggerStateList or semiPersistentOnPUSCH-TriggerStateList) for which at least one trigger state configuration is associated with the following:
   an identifier or a list of identifiers of the one or more CSI Report Setting(s), where each identifier is associated with an identifier of the CSI-RS resource set, and
   one or more power offset values, where each power offset value indicates a power offset between a PDSCH RE and an RE of the NZP-CSI-RS resource

In some embodiments, the UE may receive a DCI containing an indication of the trigger state configuration for CSI reporting and an indication of resources for uplink transmission of the CSI report. The UE may receive the NZP-CSI-RS resource associated with the trigger state. The UE may determine one or more channel state information measurements associated with the NZP-CSI-RS resource based on one or more of the power offset values. The UE may transmit at least one or more of channel state information reports on the uplink resources wherein the CSI reports may contain one or more of the following RI, CQI, PMI, CRI, SINR, RSRP, and RSRQ.

In some embodiments, a power offset associated with the indication of the trigger state configuration may override the power offset of a PDSCH RE to an NZP-CSI-RS RE (e.g., powerControlOffset parameter) configured for the NZP-CSI-RS resource. The power offset of a PDSCH RE to an NZP-CSI-RS RE for determining CSI may be determined using the power offset associated with the indication of the trigger state configuration.

In some embodiments, a power offset associated with the indication of the trigger state configuration may be an offset relative to the power offset of a PDSCH RE to an NZP-CSI-RS RE (e.g., powerControlOffset parameter) configured for the NZP-CSI-RS resource.

In some embodiments, the power offset of a PDSCH RE to an NZP-CSI-RS RE for determining CSI may be determined as an offset relative to the power offset of a PDSCH RE to an NZP-CSI-RS RE (e.g., powerControlOffset parameter) configured for the NZP-CSI-RS resource, where the offset is given by the power offset associated with the indication of the trigger state configuration.

An example IE structure is shown below with new parameter for indication of power offset(s) as follows.

A new parameter power_offset that may contain a list of power offsets (e.g., (0 dB, −1 dB, −2 dB)) is included in the CSI-AssociatedReportConfigInfo IE. The parameter for indication of power offset(s) may be as follows. For example, A can be 8 and B can be 15.
Power-Offset (sequence (SIZE(1, . . . maxNrofPowerOffsets)) of INTEGER (−A . . . B)
   where −8 to 15 dB denotes an example range of power offset, and where the field can be described as follows.

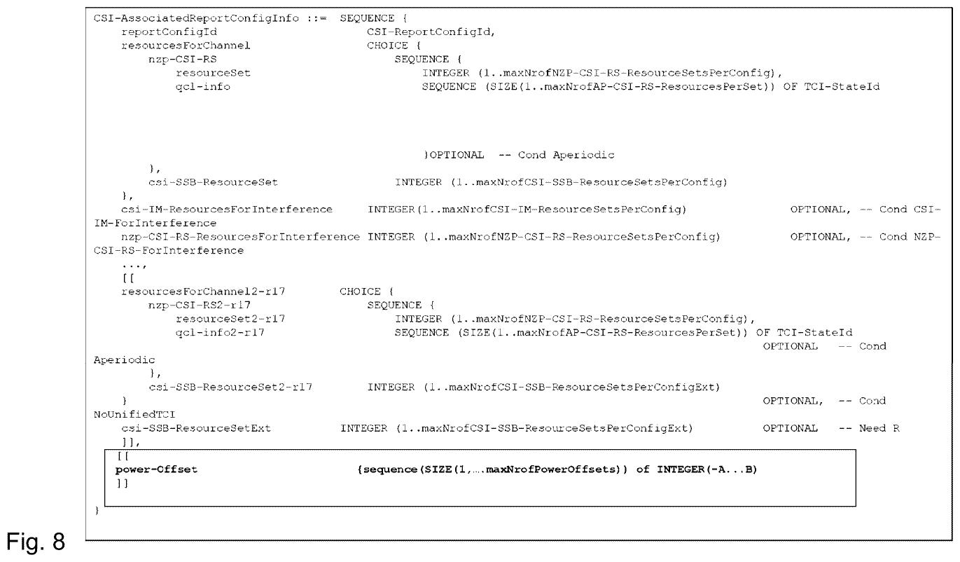

FIG. 8 illustrates example ASN.1 for a range of power offset.

In another example, a new parameter power-Offset that may contain a single power offset per resource set (e.g., (0 dB, −1 dB, −2 dB)) may be included in the CSI-AssociatedReportConfigInfo IE. The parameter for indication of power offset(s) may be as follows. For example, A can be 8 and B can be 15.
power-Offset INTEGER (−A . . . B),
where-A to B denotes the range of power offset (in dB).

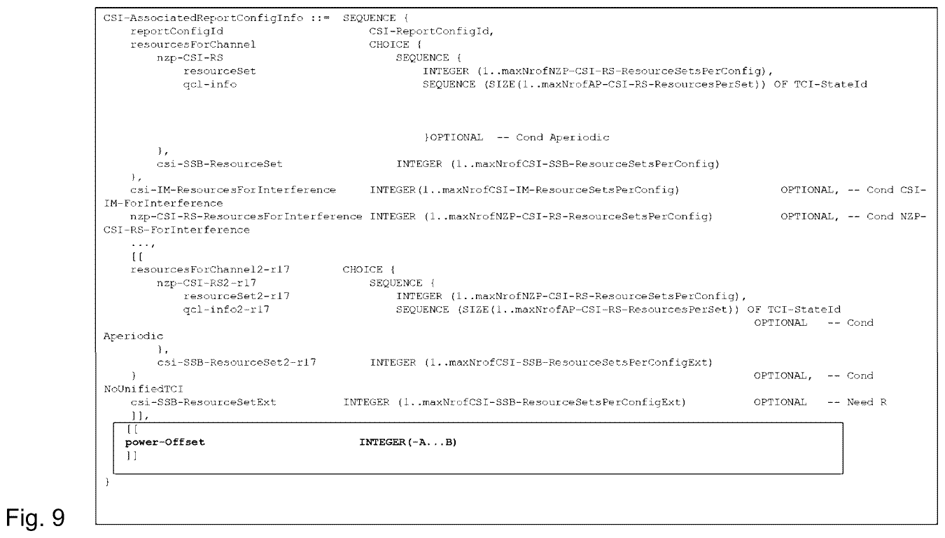

FIG. 9 illustrates another example ASN.1 for a range of power offset.

In some examples, the allowed power offsets may be in a smaller range, e.g. (−6 . . . 6) dB.

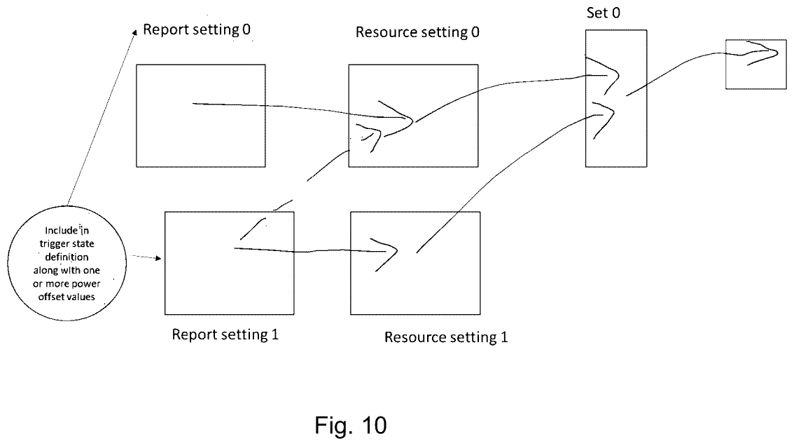

FIG. 10 illustrates an example configuration, according to particular embodiments. The illustrated example is shown for the case of 2 Report Settings. The dashed arrow shows an alternate possibility where Report setting 1 may be associated with Resource setting 0 (instead of Resource setting 1), in which case only Resource Setting 0 is configured.

In some embodiments, rather than associating the one or more power offset values with a trigger state, a power offset value may be configured within a Report Setting using IE CSI-ReportConfig.

When a power offset value, or a list of poweroffset values, is configured in CSI-Reportconfiguration, the power offset may be associated to any of aperiodic, semipersistent or periodic CSI reporting.

In some embodiments, the IE CSI-ReportConfig may be used to configure a periodic or semi-persistent report sent on PUCCH on the cell in which the CSI-ReportConfig is included. In some embodiments, the IE CSI-ReportConfig may be used to configure a semi-persistent or aperiodic report sent on PUSCH triggered by DCI received on the cell in which the CSI-ReportConfig is included (in this case, the cell on which the report is sent is determined by the received DCI).

CSI-ReportConfig information element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

| | |
|---|---|
| OPTIONAL, | -- Need S |

| | |
|---|---|
| resourcesForChannelMeasurement | CSI-ResourceConfigId, |
| csi-IM-ResourcesForInterference | CSI-ResourceConfigId |

| | |
|---|---|
| OPTIONAL, | -- Need R |

| | |
|---|---|
| nzp-CSI-RS-ResourcesForInterference | CSI-ResourceConfigId |

| | |
|---|---|
| OPTIONAL, | -- Need R |

| | |
|---|---|
| reportConfigType | CHOICE { |
| periodic | SEQUENCE { |

| | |
|---|---|
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |

| | |
|---|---|
| reportSlotConfig | CSI-ReportPeriodicityAndOffset, |
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |

| | |
|---|---|
| reportSlotConfig | ENUMERATED {sl5, sl10, sl20, |

sl40, sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| aperiodic | | SEQUENCE { |
|---|---|---|
| | reportSlotOffsetList | SEQUENCE (SIZE (1..maxNrofUL- |

```
Allocations)) OF INTEGER(0..32)
      }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |

| | |
|---|---|
| pdsch-BundleSizeForCSI | ENUMERATED {n2, n4} |

| | |
|---|---|
| OPTIONAL | -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

| reportFreqConfiguration | SEQUENCE { | |
|---|---|---|
| cqi-FormatIndicator | ENUMERATED { widebandCQI, | |
| subbandCQI } | OPTIONAL, | -- Need R |
| pmi-FormatIndicator | ENUMERATED { widebandPMI, | |
| subbandPMI } | OPTIONAL, | -- Need R |

| | |
|---|---|
| csi-ReportingBand | CHOICE { |

| subbands3 | BIT STRING(SIZE(3)), |
|---|---|
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |
| ..., | |
| subbands19-v1530 | BIT STRING(SIZE(19)) |

| | |
|---|---|
| } | OPTIONAL -- Need S |

}

| | |
|---|---|
| OPTIONAL, | -- Need R |

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | |
|---|---|
| codebookConfig | CodebookConfig |

| | |
|---|---|
| OPTIONAL, | -- Need R |

| | |
|---|---|
| dummy | ENUMERATED {n1, n2} |

| | |
|---|---|
| OPTIONAL, | -- Need R |

| | |
|---|---|
| groupBasedBeamReporting | CHOICE { |

| enabled | | NULL, |
|---|---|---|
| disabled | | SEQUENCE { |
| | nrofReportedRS | ENUMERATED {n1, n2, n3, n4} |

| | |
|---|---|
| OPTIONAL | -- Need S |

```
      }
  },
```

| | |
|---|---|
| cqi-Table | ENUMERATED {table1, table2, table3, table4-r17} |

| | |
|---|---|
| OPTIONAL | -- Need R |

| | |
|---|---|
| subbandSize | ENUMERATED {value1, value2}, |
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

}

| | |
|---|---|
| OPTIONAL | -- Need R |

```
  ]],
  [[
```

| semiPersistentOnPUSCH-v1610 | SEQUENCE { | |
|---|---|---|
| reportSlotOffsetListDCI-0-2-r16 | SEQUENCE (SIZE (1.. maxNrofUL- | |
| Allocations-r16)) OF INTEGER(0..32) | OPTIONAL, | -- Need R |
| reportSlotOffsetListDCI-0-1-r16 | SEQUENCE (SIZE (1.. maxNrofUL- | |
| Allocations-r16)) OF INTEGER(0..32) | OPTIONAL | -- Need R |

}

| | |
|---|---|
| OPTIONAL, | -- Need R |

| aperiodic-v1610 | SEQUENCE { | |
|---|---|---|
| reportSlotOffsetListDCI-0-2-r16 | SEQUENCE (SIZE (1.. maxNrofUL- | |
| Allocations-r16)) OF INTEGER(0..32) | OPTIONAL, | -- Need R |
| reportSlotOffsetListDCI-0-1-r16 | SEQUENCE (SIZE (1.. maxNrofUL- | |
| Allocations-r16)) OF INTEGER(0..32) | OPTIONAL | -- Need R |

}

| | |
|---|---|
| OPTIONAL, | -- Need R |

| | |
|---|---|
| reportQuantity-r16 | CHOICE { |
| cri-SINR-r16 | NULL, |
| ssb-Index-SINR-r16 | NULL |

}

| | |
|---|---|
| OPTIONAL, | -- Need R |

| | |
|---|---|
| codebookConfig-r16 | CodebookConfig-r16 |

| | |
|---|---|
| OPTIONAL | -- Need R |

```
  ]],
  [[
```

| | |
|---|---|
| cqi-BitsPerSubband-r17 | ENUMERATED {bits4} |

| | |
|---|---|
| OPTIONAL, | -- Need R |

| | |
|---|---|
| groupBasedBeamReporting-v1710 | SEQUENCE { |
| nrofReportedGroups-r17 | ENUMERATED {n1, n2, n3, n4] |

}

| | |
|---|---|
| OPTIONAL, | -- Need R |

| | |
|---|---|
| codebookConfig-r17 | CodebookConfig-r17 |

| | |
|---|---|
| OPTIONAL, | -- Need R |

| | |
|---|---|
| sharedCMR-r17 | ENUMERATED {enable} |

| | |
|---|---|
| OPTIONAL, | -- Need R |

| | |
|---|---|
| csi-ReportMode-r17 | ENUMERATED {mode1, mode2} |

| | |
|---|---|
| OPTIONAL, | -- Need R |

| | |
|---|---|
| numberOfSingleTRP-CSI-Mode1-r17 | ENUMERATED {n0, n1, n2} |

| | |
|---|---|
| OPTIONAL, | -- Need R |

| | |
|---|---|
| reportQuantity-r17 | CHOICE { |
| cri-RSRP-Index-r17 | NULL, |
| ssb-Index-RSRP-Index-r17 | NULL, |
| cri-SINR-Index-r17 | NULL, |
| ssb-Index-SINR-Index-r17 | NULL |

}

| | |
|---|---|
| OPTIONAL | -- Need R |

```
  ]],
  [[
```

| semiPersistentOnPUSCH-v1720 | SEQUENCE { | |
|---|---|---|
| reportSlotOffsetList-r17 | SEQUENCE (SIZE (1.. maxNrofUL- | |
| Allocations-r16)) OF INTEGER(0..128) | OPTIONAL, | -- Need R |
| reportSlotOffsetListDCI-0-2-r17 | SEQUENCE (SIZE (1.. maxNrofUL- | |
| Allocations-r16)) OF INTEGER(0..128) | OPTIONAL, | -- Need R |
| reportSlotOffsetListDCI-0-1-r17 | SEQUENCE (SIZE (1.. maxNrofUL- | |
| Allocations-r16)) OF INTEGER(0..128) | OPTIONAL | -- Need R |

}

| | |
|---|---|
| OPTIONAL, | -- Need R |

| aperiodic-v1720 | SEQUENCE { | |
|---|---|---|
| reportSlotOffsetList-r17 | SEQUENCE (SIZE (1.. maxNrofUL- | |
| Allocations-r16)) OF INTEGER(0..128) | OPTIONAL, | -- Need R |
| reportSlotOffsetListDCI-0-2-r17 | SEQUENCE (SIZE (1.. maxNrofUL- | |
| Allocations-r16)) OF INTEGER(0..128) | OPTIONAL, | -- Need R |
| reportSlotOffsetListDCI-0-1-r17 | SEQUENCE (SIZE (1.. maxNrofUL- | |
| Allocations-r16)) OF INTEGER(0..128) | OPTIONAL | -- Need R |

}

| | |
|---|---|
| OPTIONAL | -- Need R |

```
  ]],
  [[
  power-Offset-r18 SEQUENCE (SIZE (1.. maxNrofPO-r18)) OF Power-offset OPTIONAL
-- Need R
  ]]
}
```

| | |
|---|---|
| CSI-ReportPeriodicityAndOffset ::= | CHOICE { |
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| | |
|---|---|
| PortIndexFor8Ranks ::= | CHOICE { |
| portIndex8 | SEQUENCE { |
| rank1-8 | PortIndex8 |

| | |
|---|---|
| OPTIONAL, | -- Need R |

| | |
|---|---|
| rank2-8 | SEQUENCE(SIZE(2)) OF PortIndex8 |

| | |
|---|---|
| OPTIONAL, | -- Need R |

| | |
|---|---|
| rank3-8 | SEQUENCE(SIZE(3)) OF PortIndex8 |

| | |
|---|---|
| OPTIONAL, | -- Need R |

| | |
|---|---|
| rank4-8 | SEQUENCE(SIZE(4)) OF PortIndex8 |

| | |
|---|---|
| OPTIONAL, | -- Need R |

| | |
|---|---|
| rank5-8 | SEQUENCE(SIZE(5)) OF PortIndex8 |

| | |
|---|---|
| OPTIONAL, | -- Need R |

| | |
|---|---|
| rank6-8 | SEQUENCE(SIZE(6)) OF PortIndex8 |

| | |
|---|---|
| OPTIONAL, | -- Need R |

| | |
|---|---|
| rank7-8 | SEQUENCE(SIZE(7)) OF PortIndex8 |

| | |
|---|---|
| OPTIONAL, | -- Need R |

| | |
|---|---|
| rank8-8 | SEQUENCE(SIZE(8)) OF PortIndex8 |

| | |
|---|---|
| OPTIONAL | -- Need R |

},

| | |
|---|---|
| portIndex4 | SEQUENCE{ |
| rank1-4 | PortIndex4 |

| | |
|---|---|
| OPTIONAL, | -- Need R |

| | |
|---|---|
| rank2-4 | SEQUENCE(SIZE(2)) OF PortIndex4 |

| | |
|---|---|
| OPTIONAL, | -- Need R |

| | |
|---|---|
| rank3-4 | SEQUENCE(SIZE(3)) OF PortIndex4 |

| | |
|---|---|
| OPTIONAL, | -- Need R |

| | |
|---|---|
| rank4-4 | SEQUENCE(SIZE(4)) OF PortIndex4 |

| | |
|---|---|
| OPTIONAL | -- Need R |

},

| | |
|---|---|
| portIndex2 | SEQUENCE{ |
| rank1-2 | PortIndex2 |

| | |
|---|---|
| OPTIONAL, | -- Need R |

| | |
|---|---|
| rank2-2 | SEQUENCE(SIZE(2)) OF PortIndex2 |

| | |
|---|---|
| OPTIONAL | -- Need R |

},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

Power-Offset-r18 ::= INTEGER (−A..B)
-- TAG-CSI-REPORTCONFIG-STOP
-- ASN1STOP

CSI-ReportConfig field descriptions

Power-Offset
Indicates a power offset values of PDSCH RE to NZP-CSI-RS RE. UE reports based
on each configured value for the resourcesForChannelMeasurement configured for
semipersistent or periodic reporting, or triggerstate for aperiodic reporting

As mentioned above, for the sake of powerControlOffsetSS, two IEs Power-Offset-r18, and Power-OffsetSS-r18 may be included.

### Option 1B

Option 1B is similar to Option 1/1A except that the list of power offset values may be configured as an extension to the single offset configured in the NZP-CSI-RS resource instead of within the trigger state. For example, more than one power offset value may be configured within a NZP-CSI-RS resource, where each power offset value indicates a power offset between a PDSCH RE and an RE of the NZP-CSI-RS resource.

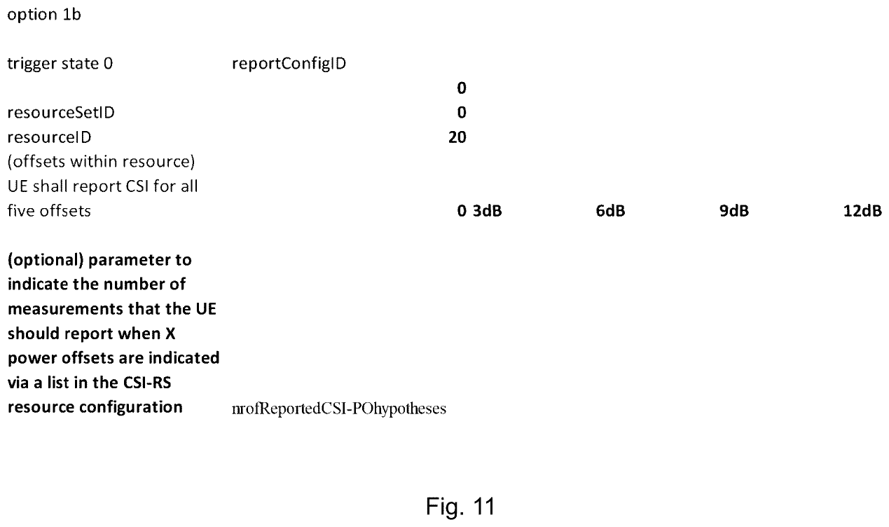

FIG. 11 is a table illustrating an example of power offset values, according to a particular embodiment.

In some embodiments, a UE may be configured with the following:
a CSI-RS resource set containing an NZP-CSI-RS resource, more than one power offset value configured within the NZP-CSI-RS resource, where each power offset value indicates a power offset between a PDSCH RE and an RE of the NZP-CSI-RS resource.
one or more CSI Resource Settings (i.e., CSI-ResourceConfig) each associated with the CSI-RS resource set where each CSI Resource Setting indicates that the CSI-RS resource set is aperiodic or semi-persistent or periodic.
one or more CSI Report Settings (i.e., CSI-ReportConfig), each associated with one of the one or more CSI Resource Settings.
an aperiodic/semi-persistent trigger state list (i.e., CSI-AperiodicTriggerStateList or semiPersistentOnPUSCH-TriggerStateList) for which at least one trigger state configuration is associated with the following (or at least an entry in the associatedReportConfigInfoList associated with the trigger state is associated with the following):
   an identifier or a list of identifiers of the one or more CSI Report Setting(s), where each identifier is associated with an identifier of the CSI-RS resource set.

In some embodiments, the UE may receive a DCI containing an indication of the trigger state configuration for CSI reporting and an indication of resources for uplink transmission of the CSI report.

The UE may receive the NZP-CSI-RS resource associated with the trigger state (e.g., further associated with an entry in the associatedReportConfigInfoList associated with the trigger state). The UE may determine one or more channel state information measurements associated with the NZP-CSI-RS resource based on one or more of the power offset values. The UE may transmit at least one or more of channel state information reports on the uplink resources wherein the CSI reports may contain one or more of the following RI, CQI, PMI, CRI, SINR, RSRP, and RSRQ.

In some embodiments, each channel state information measurement may be determined based on a respective power value configured in the NZP-CSI-RS resource.

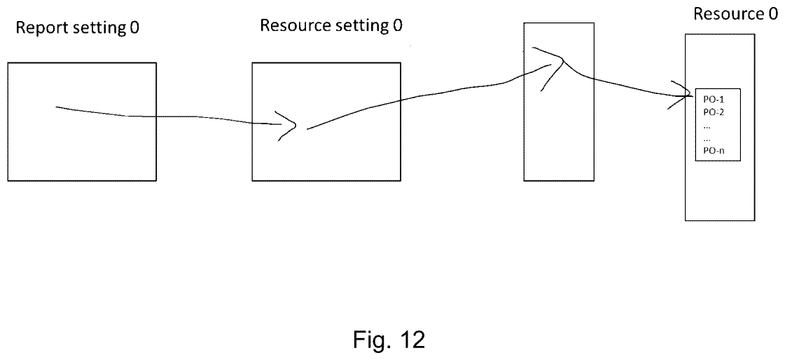

FIG. 12 illustrates another example configuration, according to a particular embodiment.

In some embodiments, a default power offset value may be specified for the NZP-CSI-RS resource when the list is not used for measurement/reporting of CSI based on multiple power offset values. A single value may be configured for legacy measurement/reporting purposes (e.g., for legacy CSI report settings), and an extended list of offset values that the UE may use for measurement/reporting of CSI based on multiple power offset values. The UE may use the appropriate power offset value(s) based on the setting/configuration.

### Option 1C

Option 1C is similar to Option 1/1A except that the list of power offset values may be configured within the CSI-RS resource set instead of within the trigger state. In addition, the CSI-RS resource set may contain one or multiple CSI-RS resources. In some embodiments, one or more power offset values may be configured within a CSI-RS resource set, where each power offset value indicates a power offset between a PDSCH RE and an RE of the NZP-CSI-RS resource.

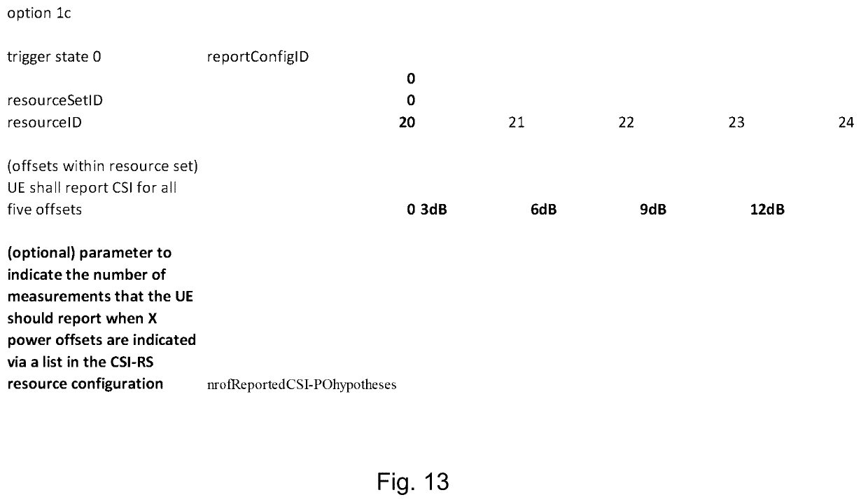

FIG. 13 is a table illustrating another example of power offset values, according to a particular embodiment. The illustrates example shows multiple CSI-RS resources in the CSI-RS resource set.

In some embodiments, a UE may be configured with the following:
a CSI-RS resource set containing one or more NZP-CSI-RS resources, and one or more power offset values configured within the CSI-RS resource set, where each power offset value indicates a power offset between a PDSCH RE and an RE of the NZP-CSI-RS resource.
one or more CSI Resource Settings (i.e., CSI-ResourceConfig) each associated with the CSI-RS resource set where each CSI Resource Setting indicates that the CSI-RS resource set is aperiodic or semi-persistent or periodic.
one or more CSI Report Settings (i.e., CSI-ReportConfig), each associated with one of the one or more CSI Resource Settings.
an aperiodic trigger state list (i.e., CSI-AperiodicTriggerStateList or semiPersistentOnPUSCH-TriggerStateList) for which at least one trigger state configuration is associated with the following:
   an identifier or a list of identifiers of the one or more CSI Report Setting(s), where each identifier is associated with an identifier of the CSI-RS resource set

In some embodiments, the UE may receive a DCI containing an indication of the trigger state configuration for CSI reporting and an indication of resources for uplink transmission of the CSI report. The UE may receive the NZP-CSI-RS resource associated with the trigger state.

The UE determines one or more channel state information measurements associated with the NZP-CSI-RS resource based on one or more of the power offset values. The UE may transmit at least one or more of channel state information reports on the uplink resources wherein the CSI reports may contain one or more of the following RI, CQI, PMI, CRI, SINR, RSRP, and RSRQ.

In an embodiment, a power offset configured within the CSI-RS resource set overrides the power offset of a PDSCH RE to an NZP-CSI-RS RE (e.g., powerControlOffset parameter) configured for the NZP-CSI-RS resource. The power offset of a PDSCH RE to an NZP-CSI-RS RE for determining CSI is determined using the power offset configured within the CSI resource set.

In some embodiments, a power offset configured within the CSI-RS resource set may be an offset relative to the power offset of a PDSCH RE to an NZP-CSI-RS RE (e.g., powerControlOffset parameter) configured for the NZP-CSI-RS resource.

In some embodiments, the power offset of a PDSCH RE to an NZP-CSI-RS RE for determining CSI may be determined as an offset relative to the power offset of a PDSCH RE to an NZP-CSI-RS RE (e.g., powerControlOffset parameter) configured for the NZP-CSI-RS resource, where the offset is given by the power offset configured within the CSI-RS resource set.

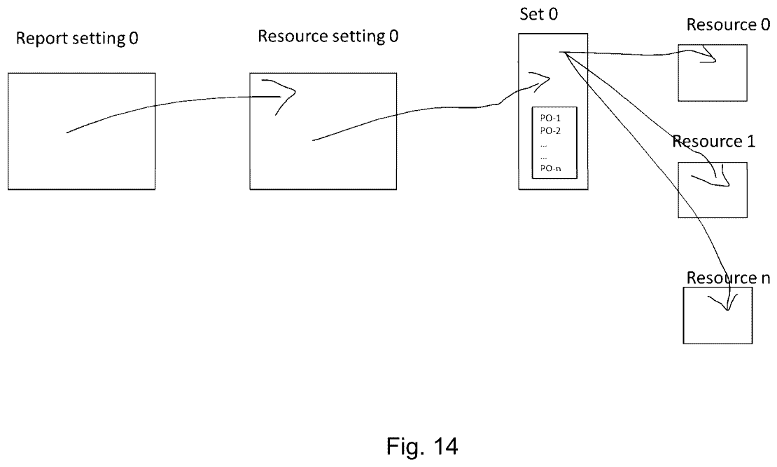

FIG. 14 illustrates another example configuration, according to a particular embodiment.

In some embodiments, a default power offset value may be specified for the NZP-CSI-RS resource when the list is not used for measurement/reporting of CSI based on multiple power offset values. A single value may be configured for legacy measurement/reporting purposes (e.g., for legacy CSI report settings), and an extended list of offset values that the UE may use for measurement/reporting of CSI based on multiple power offset values. The UE may use the appropriate power offset value(s) based on the setting/configuration.

In some embodiments, the UE may transmit a subset of the determined CSI(s) associated with a trigger state, such as the best M CSI(s).

In some embodiments, the UE may be configured with a parameter (e.g. nrofReportedCSI-POhypotheses, e.g. in the CSI report configuration or associated with a CSI report setting) that indicates the number of CSIs the UE should report when CSI request is triggered for the associated CSI report. For example, the network may configure the UE with five power settings for measurement, but may ask UE to report only two CSIs (and/or two power offset values) yielding the best throughput.

In some embodiments, the UE may report the associated CSI-RS resource identifier and/or the power offset identifier for each reported CSI on the uplink.

In some embodiments, multiple parameters may be configured to the UE for determining which and how many CSIs that the UE should report. For example, a first number of CSIs (e.g., 1) are reported if the number of power offset value(s) is a first value (e.g., 2), a second number of CSIs are reported (2) if the number of power offset value(s) is a second value (e.g., 4), and so on.

In some embodiments, the UE may be configured with a parameter (e.g., nrofReportedCSI-POhypotheses, e.g. in the trigger state configuration or per CSI report setting in a trigger state) that indicates the number of CSIs that the UE should report when CSI request is triggered for the associated CSI report.

In some embodiments, the UE transmitting step may be as follows:
receive a DCI containing
   an indication of the trigger state configuration for CSI reporting, and
   indication of resources for uplink transmission of the CSI report.
receive the NZP-CSI-RS resource(s) associated with the trigger state,
determine one or more channel state information measurements associated with the NZP-CSI-RS resource(s) based on one or more of the associated CSI resource set or CSI report setting or power offset values, and
transmit at least one or more of channel state information reports and at least an indicator of an associated CSI resource set or CSI report setting or power offset identifier on the uplink resources. The CSI reports may contain one or more of the following RI, CQI, PMI, CRI, SINR, RSRP, and RSRQ.

In some embodiments, the number of channel state information reports transmitted by the UE may be based on an indication received by the UE.

In some embodiments, the UE may not need to report the associated CSI-RS resource set, or CSI report setting or power offset identifier explicitly, and the associated identifiers may be deduced implicitly. For example, the UE may report the requested reports in a specific order according to the set, setting, or offset identifier. The order may be configured via higher layers, or pre-configured, e.g., in ascending order.

In some embodiments, the UE may expect that at least one of the CQI, SINR or RSRP to be at least one of the parameters to be reported, or at least one of them is requested by the network. One reason for this may that these parameters are directly impacted by a change in power and thus are good indication for the network to choose the appropriate power adaptation measure.

In some embodiments, the UE may report the requested parameters as a delta towards a reference value, e.g., the original power offset value.

In some embodiments, the DCI may be an existing scheduling DCI, e.g., DCI 0-1. 0-2, 1-1, 1-2, or a group common DCI, e.g., 2.0, or a new UE specific or group common DCI. The DCI may include a bitfield which request the CSI report, and potentially with the disclosed conditions in this disclosure.

In some embodiments, the UE may be configured for measurement of N CSI resources/resource sets with one or more CSI report setting (where N is greater than one), with one power offset value per measured CSI resource/resource set. The UE report may be based on the CSI resource/resource set that provides best performance (e.g., overall throughput, sum-rate, modulation and coding scheme (MCS), rank) and is also associated with the lowest power offset value (e.g., one that yield network energy savings and still provide the best performance). The UE report may include the CSI and associated power offset value identifier.

For example, the UE may determine two CSIs based on two power offset values, the first determined CSI may have a higher rank but lower MCS, and a second determined CSI may have a lower rank but higher MCS, and the UE may determine that the first determined CSI may yield lower overall throughput compared to the second determined CSI. Therefore, if UE is to report one CSI, it may transmit the second determined CSI and associated power offset indication on the uplink to the gNB.

In another example, if the UE determines two CSI resources/resource sets associated with different power offset values that provide same/similar performance (e.g., same/similar sum rate, MCS, rank, throughput), the UE report may be based on the CSI resource/resource set with lower power offset value among the two CSI resources/resource sets.

In some embodiments, the UE may report the CSI and associated power offset that has the best overall throughput (sum-rate) subject to a constraint where the power offset value shall be greater than or equal to a threshold, where the threshold is indicated to the UE. The threshold may be indicated to the UE via a MAC Control Element, RRC, DCI, etc.

In some embodiments, the UE may be configured for measurement of N CSIs with a CSI report setting, with one power offset value per measured CSI. The UE may report M CSI and associated power offset value identifier(s) that has the M best overall throughput (sum-rate) (for example, one that yields network energy savings and still provides the best throughput compared to others), where each of N and M may be one or larger. In some embodiments, M may be explicitly signaled to the UE.

In some embodiments, the UE may be configured for measurement of N CSIs with a CSI report setting, with one power offset value per measured CSI. The UE may report at least M power offset value identifier(s) that have the best overall throughput (sum-rate) and at least one CSI associated with at least one of the M power offset value identifiers, where each of N and M may be one or larger. In some embodiments, M may be explicitly signaled to the UE.

In some embodiments, the UE may be required to report the parameters or CSIs that are changed with respect to the reference configuration, e.g., the original configuration. For example, the UE may be configured to report CQI and RI for 4 different offset values, but the RI does not change between the values. In such cases, the UE does not need to report non-changing values, and may report the CQI if the CQI changes. If the CQI and/or RI do not change for one or more of offset values, the COI and/or RI do not need to be reported for those values.

Below shows an example where UE performs multiple CSI measurements but reports only a subset of them.

In some embodiments, the UE may be configured with the following:
CSI-RS resource set(s) containing NZP-CSI-RS resource(s).
one or more CSI Resource Settings each associated with the CSI-RS resource set(s) where each CSI Resource Setting indicates that the CSI-RS resource set is aperiodic or semi-persistent or periodic.
one or more CSI Report Settings, each associated with one of the one or more CSI Resource Settings.
a trigger state list for which at least one trigger state configuration is associated with the following:
   an identifier or a list of identifiers of the one or more CSI Report Setting(s), where each identifier is associated with an identifier of the CSI-RS resource set(s)

In some embodiments, the UE may receive a DCI containing an indication of the trigger state configuration for CSI reporting and an indication of resources for uplink transmission of the CSI report. The UE may receive the NZP-CSI-RS resource(s) associated with the trigger state. The UE may determine one or more channel state information measurements associated with the NZP-CSI-RS resource(s). The UE may transmit at least one or more of channel state information reports and at least one of an identifier of the one or more CSI Report settings/indicator of an associated resource set/indicator of an associated CSI resource on the uplink resources wherein the CSI reports can contain one or more of the following RI, CQI, PMI, CRI, SINR, RSRP, and RSRQ. In some embodiments, the number of channel state information reports transmitted may be based on an indication received by the UE.

In some embodiments, a UE supporting the enhanced CSI reporting mechanism described above may indicate via UE capability the maximum number of simultaneous power offsets (e.g., in a trigger state for a same CSI report setting/CSI resource setting/CSI-RS resource set/CSI resource) that it may support for the enhanced CSI calculation.

In some embodiments, a UE supporting the enhanced CSI reporting mechanism described above may indicate via UE capability the maximum number of simultaneous CSI reports (e.g., in a trigger state for a same CSI report setting/CSI resource setting/CSI-RS resource set/CSI resource) that it may support for the enhanced CSI reporting.

In some embodiments, a UE supporting the enhanced CSI reporting mechanism described above may indicate via UE capability the maximum number of simultaneous CSI reports (e.g., in a trigger state for a same CSI report setting/CSI resource setting/CSI-RS resource set/CSI resource) that it may support for the enhanced CSI reporting when one or more SCell are deactivated or in a dormant BWP. This may enable a UE to borrow the CSI computation resources from another carrier when the other carrier is not in use (e.g., deactivated or in dormant BWP). The UE may also indicate the SCells/carriers from which CSI computation resources may be borrowed for the purposes of enhanced CSI reporting on a given cell/carrier.

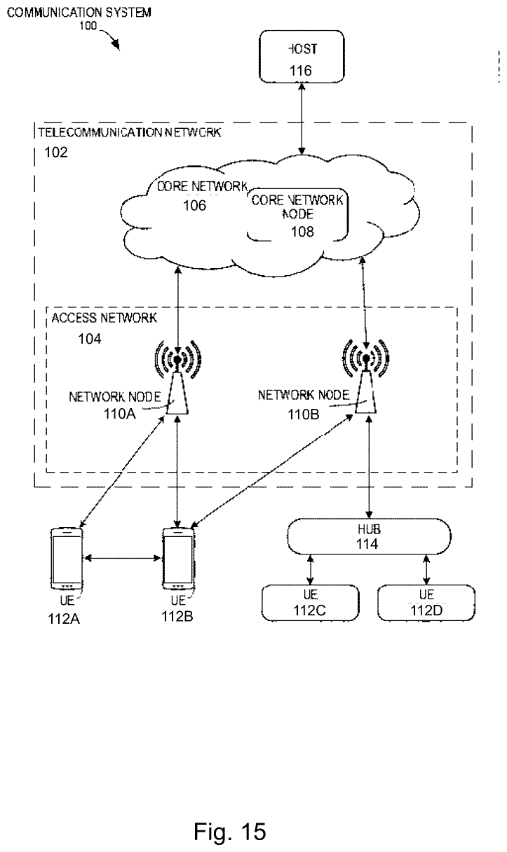

FIG. 15 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G): wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

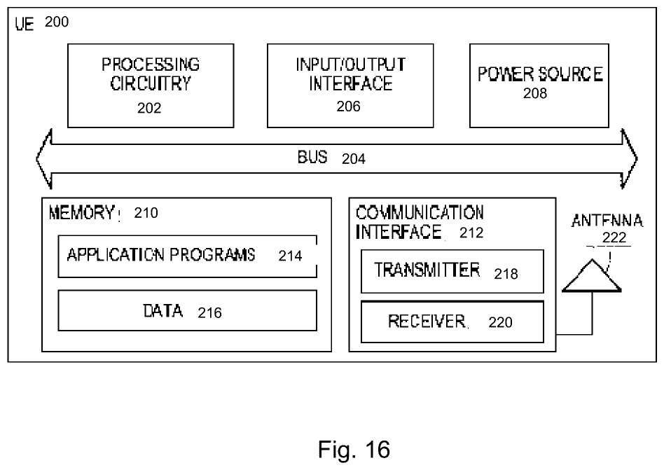

FIG. 16 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216, The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data, An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

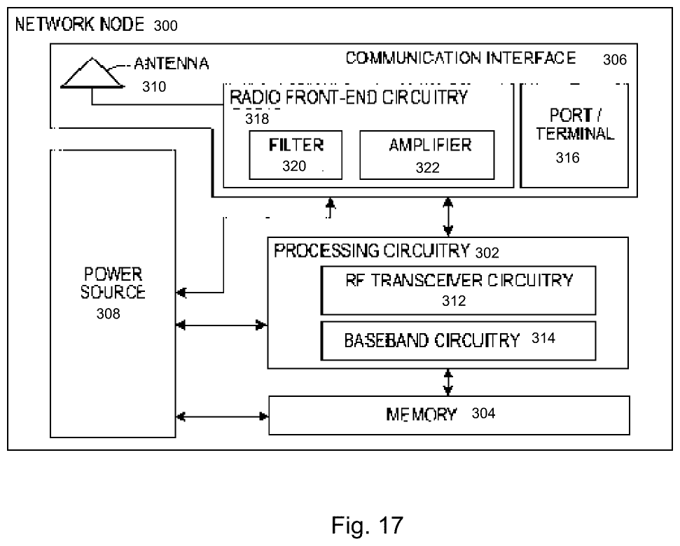

FIG. 17 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations, A base station may be a relay node or a relay donor node controlling a relay, A network node may also include one or more (or all) parts of a distributed radio base station such as centralized digital units and/or remote radio units (RRUs), sometimes referred to as Remote Radio Heads (RRHs), Such remote radio units may or may not be integrated with an antenna as an antenna integrated radio, Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308, The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs), In such embodiments, some components may be duplicated (e.g., separate memory 304 for different RATs) and some components may be reused (e.g., a same antenna 310 may be shared by different RATs), The network node 300 may also include multiple sets of the various illustrated components for different wireless technologies integrated into network node 300, for example GSM, WCDMA. LTE, NR. WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 17 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

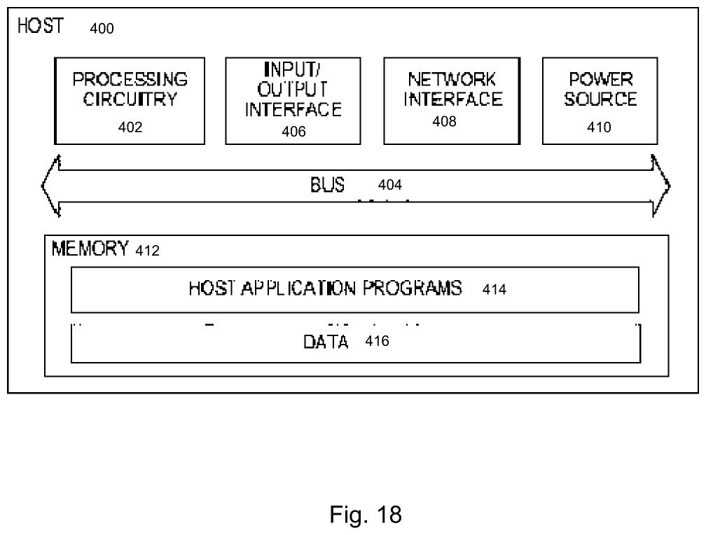

FIG. 18 is a block diagram of a host 400, which may be an embodiment of the host 116 of FIG. 15, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

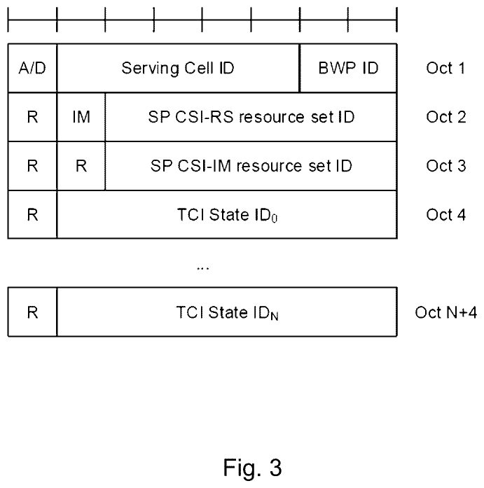

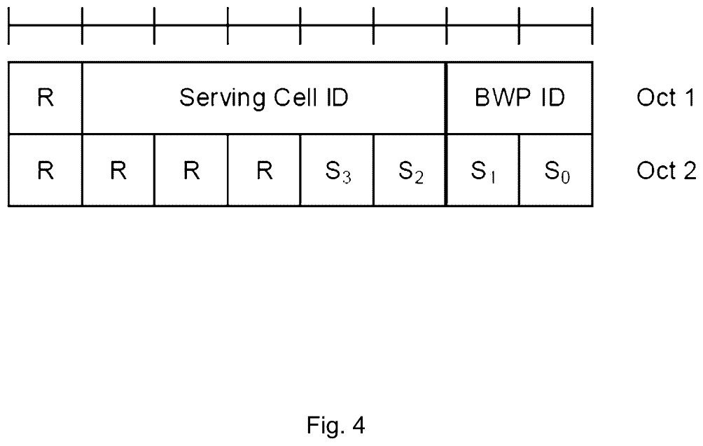

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 3 and 4, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

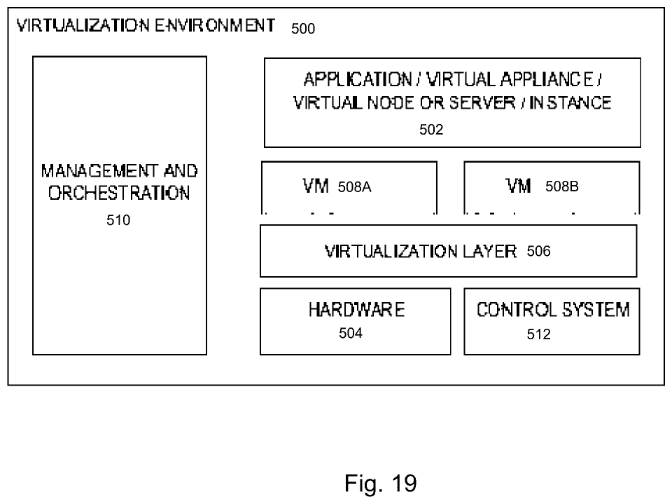

FIG. 19 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

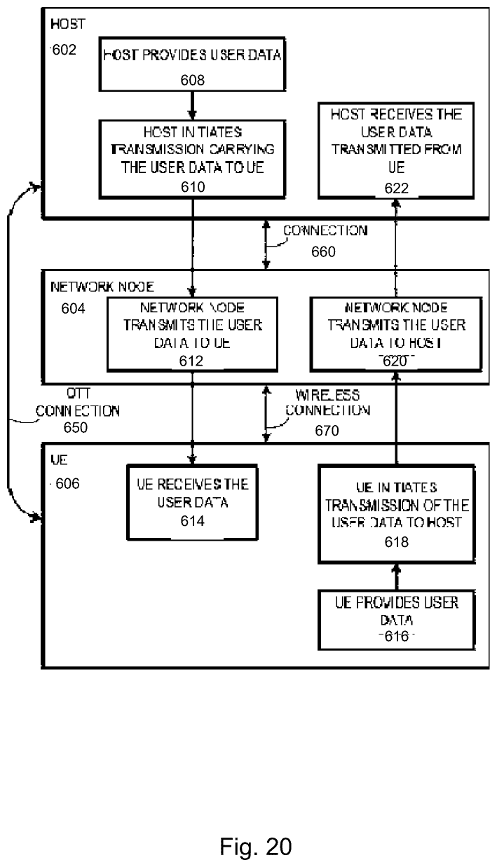

FIG. 20 shows a communication diagram of a host 602 communicating via a network node 604 with a UE 606 over a partially wireless connection in accordance with some embodiments. Example implementations, in accordance with various embodiments, of the UE (such as a UE 112a of FIG. 15 and/or UE 200 of FIG. 16), network node (such as network node 110a of FIG. 15 and/or network node 300 of FIG. 17), and host (such as host 116 of FIG. 15 and/or host 400 of FIG. 18) discussed in the preceding paragraphs will now be described with reference to FIG. 20.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 15) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the delay to directly activate an SCell by RRC and power consumption of user equipment and thereby provide benefits such as reduced user waiting time and extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes: the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.: the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

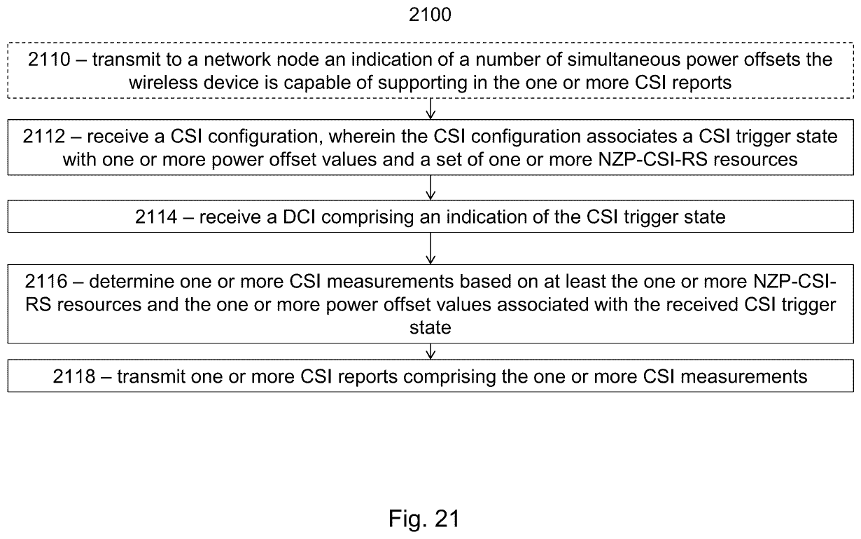

FIG. 21 is a flowchart illustrating an example method in a wireless device, according to certain embodiments. In particular embodiments, one or more steps of FIG. 21 may be performed by UE 200 described with respect to FIG. 16.

The method may begin at step 2110, where the wireless device (e.g., UE 200) transmits capability information to a network node. For example, the wireless device may transmit an indication of a number of simultaneous power offsets the wireless device is capable of supporting in one or more CSI reports. Examples of other capability information are provided with respect to the embodiments described herein.

At step 2112, the wireless device receives a CSI configuration. The CSI configuration associates a CSI trigger state with one or more power offset values and a set of one or more NZP-CSI-RS resources. In particular embodiments, the CSI configuration associates the CSI trigger state with two or more power offset values and a set of one or more NZP-CSI-RS resources.

In particular embodiments, the one or more power offset values associated with the CSI trigger state comprise an offset relative to a power offset value configured for an associated NZP-CSI-RS resource or override a power offset configured for an associated NZP-CSI-RS resource.

In particular embodiments, the power offset value comprises a power offset between a RE of a PDSCH and a RE of a NZP-CSI RS resource or a power offset between the NZP-CSI-RS resource and an RE of a SS/PBCH block.

In particular embodiments, the CSI trigger state corresponds to aperiodic CSI reporting or semi-static CSI reporting on a PUSCH.

The wireless device may receive the CSI configuration via signaling, such as RRC signaling. The power offset values may be configured via different information elements. In particular embodiments, the CSI trigger state is associated with the one or more power offset values based on a trigger state configuration comprising one or more power offset values, based on a NZP-CSI-RS resource configuration comprising one or more power offset values, based on a NZP-CSI-RS resource set configuration comprising one or more power offset values, and/or based on a report configuration comprising one or more power offset values.

Additional examples of CSI configuration with one or more power offset values are provided with respect to the embodiments described herein.

At step 2114, the wireless device receives a DCI comprising an indication of the CSI trigger state. The trigger causes the method to continue to step 2116.

At step 2116, the wireless device determines one or more CSI measurements based on at least the one or more NZP-CSI-RS resources and the one or more power offset values associated with the received CSI trigger state.

At step 2118, the wireless device transmits one or more CSI reports comprising the one or more CSI measurements. In particular embodiments, the one or more CSI reports comprise an indication (explicit or implicit) of one or more power offsets used for generating the CSIs in the one or more CSI reports. In particular embodiments, the one or more CSI reports comprise CSIs for a fewer number of power offsets than a number of power offsets configured in a CSI report configuration (e.g., best K CSIs out of N configured). Additional examples of CSI reporting are provided with respect to the embodiments described herein.

Modifications, additions, or omissions may be made to method 2100 of FIG. 21. Additionally, one or more steps in the method of FIG. 21 may be performed in parallel or in any suitable order.

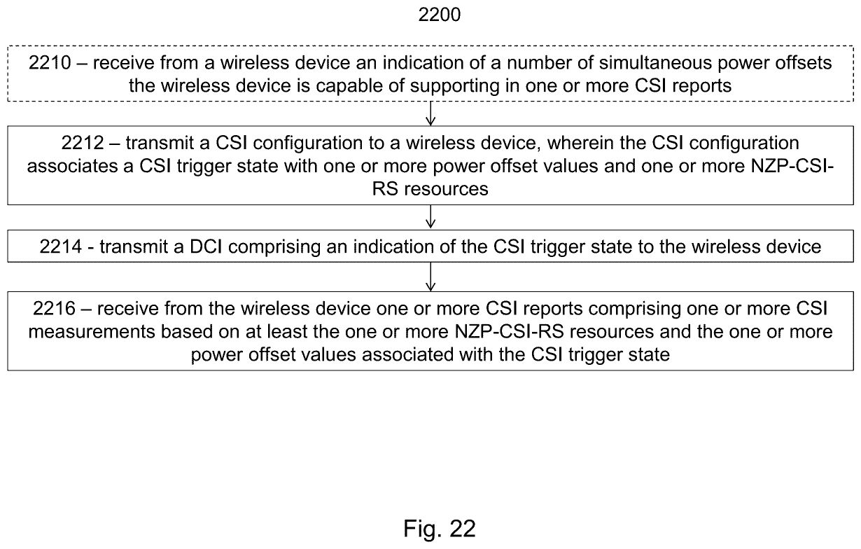

FIG. 22 is a flowchart illustrating an example method in a network node, according to certain embodiments. In particular embodiments, one or more steps of FIG. 22 may be performed by network node 300 described with respect to FIG. 17.

The method may begin at step 2210, where the network node (e.g., network node 300) receives capability information from a wireless device, such as an indication of a number of simultaneous power offsets the wireless device is capable of supporting in one or more CSI reports. Examples of other capability information are provided with respect to the embodiments described herein.

At step 2212, the network node transmits a CSI configuration to the wireless device. The CSI configuration associates a CSI trigger state with one or more power offset values and one or more NZP-CSI-RS resources. The CSI configuration is described in more detail above with respect to FIG. 21 and the embodiments and examples described herein.

At step 2214, the network node transmits a DCI comprising an indication of the CSI trigger state to the wireless device. The DCI triggers the wireless device to make CSI measurements based on the configured one or more power offset values.

At step 2216, the network node receives from the wireless device one or more CSI reports comprising one or more CSI measurements based on at least the one or more NZP-CSI-RS resources and the one or more power offset values associated with the CSI trigger state. The CSI reports are described in more detail with respect to FIG. 21 and the embodiments and examples described herein.

Modifications, additions, or omissions may be made to method 2200 of FIG. 22. Additionally, one or more steps in the method of FIG. 22 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment.” “an example embodiment.” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are described below.

### Group A Embodiments

1. A method performed by a user equipment for channel state information (CSI) reporting based on multiple power offsets, the method comprising:
   receiving a downlink control information (DCI) that comprises an indication of a trigger state configuration for CSI reporting and an indication for uplink transmission of the CSI reporting;
   receiving a non-zero power (NZP) CSI reference signal (SI) resource associated with the trigger state;
   determining one or more CSI measurements associated with the NZP CSI-RS resource based at least on one or more power offset values; and
   transmitting one or more CSI reports comprising the one or more CSI measurements.
2. The method of the previous embodiment, wherein the one or more CSI reports comprises at least one of the following:
a resource information (RI);
a channel quality indicator (CQI);
a precoding matrix indicator (PMI);
a CSI-RS resource indicator (CRI);
a signal to interference noise ratio (SINR);
a received signal reference power (RSRP); and
a received signal reference quality (RSRQ).

3. The method of any one of the previous embodiments, wherein a power offset associated with the indication of the trigger state configuration overrides a power offset of a physical downlink shared channel (PDSCH) resource element (RE) to an NZP CSI-RS RE configured for a NZP CSI-RS resource.
4. The method of any one of the previous embodiments, wherein a power offset associated with the indication of the trigger state configuration is an offset relative to a power offset of a physical downlink shared channel (PDSCH) resource element (RE) to an NZP CSI-RS RE configured for a NZP CSI-RS resource.
5. The method of any one of the previous embodiments, wherein the one or more power offset values comprise:
   a power control offset that indicates a power offset between a physical downlink shared channel (PDSCH) and a resource element (RE) of a NZP CSI reference signal (SI) resource; or
   a power control offset synchronization signal that indicates a power offset between the NZP CSI-RS resource and a secondary synchronization signal (SSS) RE.
6. The method of any one of the previous embodiments, wherein:
   a setting of the CSI reporting is associated with the trigger state configuration; and
   if a resource setting linked to a CSI report configuration has multiple aperiodic or semi-persistent resource sets, more than one of the multiple aperiodic or semi-persistent resource sets are associated with the trigger state configuration.
7. The method of any one of the previous embodiments, further comprising:
   configuring one or more power offset values in a NZP CSI reference signal (SI).
8. The method of any one of the previous embodiments, further comprising:
   configuring the one or more power offset values in the trigger state configuration.
9. The method of any one of the previous embodiments, wherein the one or more power offset values are configured as an extension to a single offset configured in the NZP CSI-RS resource.
10. The method of any one of the previous embodiments, wherein the one or more power offset values are configured within a set of CSI-RS resources.
11. The method of any one of the previous embodiments, further comprising:
   transmitting at least one of an indicator of an associated CSI resource set, a CSI report setting, and/or a power offset identifier.
12. A method performed by a wireless device, the method comprising:
   any of the wireless device steps, features, or functions described above, either alone or in combination with other steps, features, or functions described above.
13. The method of the previous embodiment, further comprising one or more additional wireless device steps, features or functions described above.
14. The method of any of the previous embodiments, further comprising:
   providing user data; and
   forwarding the user data to a host via the transmission to the network node.

### Group B Embodiments

15. A method performed by a network node for channel state information (CSI) reporting based on multiple power offsets, the method comprising:
   requesting a wireless device to report one or more CSI measurements according to one or more power offset settings; and
   receiving one or more CSI reports comprising the one or more CSI measurements, wherein the one or more CSI measurements are associated with one or more power offset values.
16. The method of the previous embodiment, further comprising:
   requesting the wireless device to report the one or more CSI measurements periodically or semi-statically; and
   receiving the one or more CSI reports periodically or semi-statically.
17. The method of any one of the previous embodiments, further comprising:
   configuring the wireless device with multiple CSI reference signal (SI) resource sets for a semi-statis or a periodic CSI reporting.
18. A method performed by a base station, the method comprising:
   any of the steps, features, or functions described above with respect to base station, either alone or in combination with other steps, features, or functions described above.
19. The method of any one of the previous embodiments, further comprising one or more additional base station steps, features or functions described above.
20. The method of any of the previous embodiments, further comprising:
   obtaining user data; and
   forwarding the user data to a host or a user equipment.

### Group C Embodiments

21. A user equipment for channel state information (CSI) reporting based on multiple power offsets, comprising:
   processing circuitry configured to perform any of the steps of any of the Group A embodiments; and
   power supply circuitry configured to supply power to the processing circuitry.
22. A network node for channel state information (CSI) reporting based on multiple power offsets, the network node comprising:
   processing circuitry configured to perform any of the steps of any of the Group B embodiments;
   power supply circuitry configured to supply power to the processing circuitry.
23. A user equipment (UE) for channel state information (CSI) reporting based on multiple power offsets, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
24. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
25. The host of the previous embodiment, wherein the cellular network further includes a network node configured to communicate with the UE to transmit the user data to the UE from the host.
26. The host of the previous 2 embodiments, wherein:
   the processing circuitry of the host is configured to execute a host application, thereby providing the user data; and
   the host application is configured to interact with a client application executing on the UE, the client application being associated with the host application.
27. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
28. The method of the previous embodiment, further comprising:
   at the host, executing a host application associated with a client application executing on the UE to receive the user data from the UE.
29. The method of the previous embodiment, further comprising:
   at the host, transmitting input data to the client application executing on the UE, the input data being provided by executing the host application,
   wherein the user data is provided by the client application in response to the input data from the host application.
30. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
31. The host of the previous embodiment, wherein the cellular network further includes a network node configured to communicate with the UE to transmit the user data from the UE to the host.
32. The host of the previous 2 embodiments, wherein:
   the processing circuitry of the host is configured to execute a host application, thereby providing the user data; and
   the host application is configured to interact with a client application executing on the UE, the client application being associated with the host application.
33. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
34. The method of the previous embodiment, further comprising:
   at the host, executing a host application associated with a client application executing on the UE to receive the user data from the UE.
35. The method of the previous embodiment, further comprising:
   at the host, transmitting input data to the client application executing on the UE, the input data being provided by executing the host application,
   wherein the user data is provided by the client application in response to the input data from the host application.
36. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
37. The host of the previous embodiment, wherein:
   the processing circuitry of the host is configured to execute a host application that provides the user data; and
   the UE comprises processing circuitry configured to execute a client application associated with the host application to receive the transmission of user data from the host.
38. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
39. The method of the previous embodiment, further comprising, at the network node, transmitting the user data provided by the host for the UE.
40. The method of any of the previous 2 embodiments, wherein the user data is provided at the host by executing a host application that interacts with a client application executing on the UE, the client application being associated with the host application.
41. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
42. The communication system of the previous embodiment, further comprising:
   the network node; and/or
   the user equipment.
43. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
44. The host of the previous 2 embodiments, wherein:
   the processing circuitry of the host is configured to execute a host application, thereby providing the user data; and
   the host application is configured to interact with a client application executing on the UE, the client application being associated with the host application.
45. The host of the any of the previous 2 embodiments, wherein the initiating receipt of the user data comprises requesting the user data.
46. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
47. The method of the previous embodiment, further comprising at the network node, transmitting the received user data to the host.

1. A method performed by a wireless device for channel state information, CSI, reporting based on a power offset, the method comprising:
receiving a CSI configuration, wherein the CSI configuration associates a CSI trigger state with one or more power offset values and a set of one or more non-zero power, NZP, CSI reference signal, RS, resources;
receiving a downlink control information, DCI, comprising an indication of the CSI trigger state;
determining one or more CSI measurements based on at least the one or more NZP-CSI-RS resources and the one or more power offset values associated with the received CSI trigger state; and
transmitting one or more CSI reports comprising the one or more CSI measurements.

2. The method of claim 1, wherein the CSI configuration associates the CSI trigger state with two or more power offset values and a set of one or more NZP-CSI-RS resources.

3. The method of claim 1, wherein the one or more power offset values associated with the CSI trigger state comprise an offset relative to a power offset value configured for an associated NZP-CSI-RS resource.

4. The method of claim 1, wherein the one or more power offset values associated with the CSI trigger state override a power offset configured for an associated NZP-CSI-RS resource.

5. The method of claim 1, wherein the power offset value comprises a power offset between a resource element, RE, of a physical downlink shared channel, PDSCH, and a RE of a NZP-CSI RS resource or a power offset between the NZP-CSI-RS resource and an RE of a synchronization signal/physical broadcast channel, SS/PBCH, block.

6. The method of claim 1, wherein the CSI trigger state corresponds to aperiodic CSI reporting or semi-static CSI reporting on a physical uplink shared channel, PUSCH.

7. The method of claim 1, wherein the CSI trigger state is associated with the one or more power offset values based on a trigger state configuration comprising one or more power offset values.

8. The method of claim 1, wherein the CSI trigger state is associated with the one or more power offset values based on a NZP-CSI-RS resource configuration comprising one or more power offset values or a NZP-CSI-RS resource set configuration comprising one or more power offset values.

9. The method of claim 1, wherein the CSI trigger state is associated with the one or more power offset values based on a report configuration comprising one or more power offset values.

10. The method of claim 1, wherein the one or more CSI reports comprise an indication of one or more power offsets used for generating the CSIs in the one or more CSI reports.

11. The method of claim 1, wherein the one or more CSI reports comprise CSIs for a fewer number of power offsets than a number of power offsets configured in a CSI report configuration.

12. The method of claim 1, further comprising transmitting to a network node an indication of a number of simultaneous power offsets the wireless device is capable of supporting in the one or more CSI reports.

13. A wireless device capable of channel state information, CSI, reporting based on a power offset, the wireless device comprising processing circuitry operable to:
receive a CSI configuration, wherein the CSI configuration associates a CSI trigger state with one or more power offset values and a set of one or more non-zero power, NZP, CSI reference signal, RS, resources;
receive a downlink control information, DCI, comprising an indication of the CSI trigger state;
determine one or more CSI measurements based on at least the one or more NZP-CSI-RS resources and the one or more power offset values associated with the received CSI trigger state; and
transmit one or more CSI reports comprising the one or more CSI measurements.

14.-24. (canceled)

25. A method performed by a network node, the method comprising:
transmitting a channel state information, CSI, configuration to a wireless device, wherein the CSI configuration associates a CSI trigger state with one or more power offset values and one or more non-zero power, NZP, CSI reference signal, RS, resources;
transmitting a downlink control information, DCI, comprising an indication of the CSI trigger state to the wireless device; and
receiving from the wireless device one or more CSI reports comprising one or more CSI measurements based on at least the one or more NZP-CSI-RS resources and the one or more power offset values associated with the CSI trigger state.

26.-35. (canceled)

36. The method of any one of claims 25-35, further comprising receiving (2210) from the wireless device an indication of a number of simultaneous power offsets the wireless device is capable of supporting in one or more CSI reports.

37. A network node comprising processing circuitry operable to:
transmit a channel state information, CSI, configuration to a wireless device, wherein the CSI configuration associates a CSI trigger state with one or more power offset values and one or more non-zero power, NZP, CSI reference signal, RS, resources;
transmit a downlink control information, DCI, comprising an indication of the CSI trigger state to the wireless device; and
receive from the wireless device one or more CSI reports comprising one or more CSI measurements based on at least the one or more NZP-CSI-RS resources and the one or more power offset values associated with the CSI trigger state.

38.-48. (canceled)
